(19) United States
(12) Patent Application Publication
(10) Pub. No.: US 2005/0277431 A1
(43) Pub. Date: Dec. 15, 2005

(54) System and method for managing wireless data communications

(75) Inventor: Russell William White, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, LP

(21) Appl. No.: 10/867,280

(22) Filed: Jun. 14, 2004

(51) Int. Cl. H04Q 7/20

(52) U.S. Cl. 455/466; 455/433

(57) ABSTRACT

A system and method are disclosed that may help a user manage wireless data communications. As part of the method, a user may communicatively link a wireless enabled device, like a cellular telephone, to a local area network (LAN) that may include other and different electronic devices. The phone may receive a data call that includes a message sent using SMS, EMS, MMS, or some other service. The phone may send information contained in the data call via the LAN to a different LAN connected electronic device. If the different electronic device has an associated display, an image representing the information may be presented on the display.

### FIELD OF THE INVENTION

The present invention relates generally to wireless communication, and more specifically to a method and system for managing wireless data communications.

### BACKGROUND

Consumers are showing an increased interest in mobile data services as wireless carriers complete well-executed launches of General Packet Radio Service (GPRS) networks. Consumers appear to be attracted to mobile data offerings like Web browsing and messaging services. Wireless messaging services, once limited to electronic mail services and Short Message Service (SMS), have expanded into Instant Messaging (IM) and Multi-media Messaging Service (MMS).

These offerings, and others, are helping to build and drive the volume of wireless data. As such, the telecommunications industry may be at a point at which the pieces are in place for operators to become aggressive in creating and deploying new data services. While high quality mobile devices like smartphones and Personal Digital Assistant's (PDA's) are available today, users are finding that the currently available devices have some significant shortcomings.

Many currently available wireless data devices lack the audio, visual, and/or display functionality necessary to properly enjoy received content. These devices may also suffer from inadequate or intermittent wireless data connections. In addition, consumers often find that wireless data-ready devices have a very short battery life when using MMS or other high bandwidth services. Compounding these issues, many consumers operate under a constrained wireless data plan with too high a cost for data traffic or too low a quality of service.

The typical solution to these problems has been to throw more technology at the end-user mobile device. While this should help to resolve some of the problems, this technique is incomplete.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents an illustration of an embodiment of an integrated wireless and wireline communication system that incorporates teachings of the present disclosure;

FIG. 2 presents an illustration of a communication system that may be used to implement teachings of the present disclosure;

FIG. 3 presents a flow diagram illustrating feature activation for a method of managing wireless data communication;

FIG. 4 depicts a user interface associated with a communication system that may be used to implement teachings of the present disclosure; and

FIG. 5 depicts a communication system that may be used to implement teachings of the present disclosure to present messages on an alternate device.

### DETAILED DESCRIPTION OF THE DRAWINGS

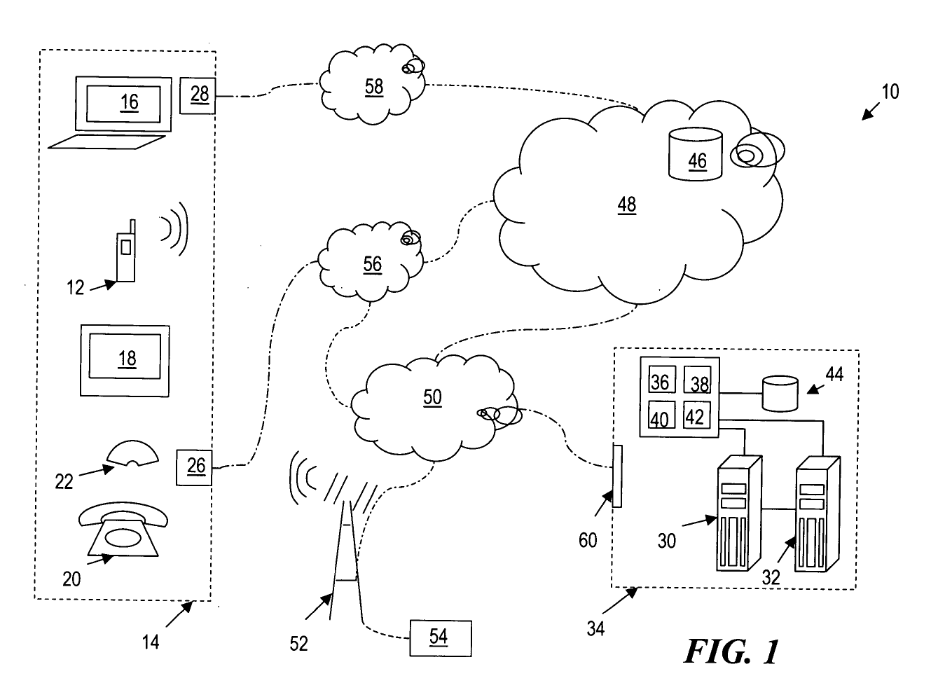

As mentioned above, FIG. 1 illustrates an integrated communication system 10 that incorporates teachings of the present disclosure. The following description is generally directed to an embodiment that routes wireless data calls originally intended for a wireless-enabled data device to a different electronic device. One skilled in the art will also recognize that the system may be operated in other directions. In some cases, the different electronic device may be associated with a wireline communication network.

For example, system 10 may support a wireless subscriber who has an SMS capable wireless telephone 12. When the subscriber is at home, at the office, or some other defined area 14 near a computer 16 or other electronic device, the subscriber may want SMS messages addressed to wireless telephone 12 to be “re-routed” to or “presented” on the subscriber's computer 16. Other electronic devices may include, for example, a television 18, a Plain Old Telephony Service (POTS) telephone 20, or a wireless local area network hub 22.

As mentioned above, a subscriber may want an SMS message re-routed to wireless local area network (WLAN) hub 22, which may be connected to a wireline network 24 via an xDSL modem 26 or a cable modem 28. WLAN hub 22 may be configured to send the messages to a display in the subscriber's home such as a display associated with television 18 or computer 16. To ensure the satisfaction of the user's re-route desires, a service provider may make use of session initiation protocol (SIP).

SIP offers a text-based description protocol that allows two systems to describe a media stream, which may be for example voice traffic, that needs to get from point A to point B. The description itself may include information relating to authentication, caller ID, media stream parameters, and/or other information for supporting a call between the two endpoints.

In operation, a call intended for a dialed number may be received in network on a channel. A call receipt process may begin in order to learn what to do and where to “send” the received call. For example, a dialed number, or some other type of device address may be translated into a variable for use during call processing activities. The processing activities may include, for example, a number of match tests performed against the variable. These match tests may be executed until a match is found.

A found match may have several allocated operators. These operations may have a priority indicator or number telling a processing server in what order the server should attempt to execute the applications associated with the found match. If, for example, there are three operations associated with a given match, a SIP-based system may prioritize the operations by giving them respective priority values of 1, 2, and 3—telling the processing server to try the priority 1 operation first.

In one embodiment, if an inbound call is directed to a dialed number, 345-6789, a variable value of 6789 may be assigned to the dialed number. The variable may then be compared against a list of match statements to determine how to handle the call. If the priority 1 application for the match is “Dial,” this application may be performed.

The Dial application may direct the processing server to ring a remote channel and then connect the two channels together if the call is answered. The Dial application may also have additional capabilities. As mentioned above, if a Dial application gets an answer on the remote channel, the two callers may be bridged together and the call may proceed. After the call, one or both parties to the call may elect to hang up. When this occurs, the Dial routine may exit with a non-zero status, and the priority list may stop executing because the call is terminated.

In some cases, there may be no answer to the call launched by the Dial application. If, for example, the Dial application rings a remote phone for some set amount of time, which may be specified in a Dial statement, and there is no answer, Dial may exit and the next priority application may be executed. In many cases, the next application may be a voicemail application, and the caller may hear an “unavailable” greeting for the called party.

If the Dial application gets a “busy” answer back from the remote phone, or the remote phone is not on-line, the Dial application may apply an adder value to the existing priority value—allowing the processing server to bypass the level 2 priority and route directly to a level 3 or higher priority application. For example, the caller may be routed to a “busy” greeting for the called party.

A service provider may elect to provide SIP-like functionality using several different architectures. Depending upon implementation detail, some SIP components may be combination modules or discrete modules, implemented in software, hardware, and/or firmware. From a high level, many SIP system components may be acting as or executing user agents and/or SIP servers.

For example, telephony devices may include user agents (UAs), which may be a combination of a user agent client (UAC) and a user agent server (UAS). In operation, a UAC entity may be permitted to create an original request, and a UAS may represent one or more server types capable of receiving requests and sending back responses. A SIP UA may be implemented in hardware such as an IP phone or a gateway component or in software such as a softphone application running on a computing platform.

Various SIP UAs may connect to one another with the help of a collection of SIP servers. In many cases, these SIP servers may be executing on centralized hosts of a distributed communication network. Again depending upon implementation detail, a large SIP system may include several different kinds of servers such as Location Servers, Proxy Servers, Redirect Servers, and Registrar Servers.

In operation, a Location Server may be used by a Redirect server or a Proxy Server to obtain information about a called party's location. A Proxy Server may represent an intermediary program that acts as both a server and a client for the purpose of making requests on behalf of other clients. Such requests may be serviced internally or transferred to other servers. In some cases, a Proxy Server may interpret and then rewrite a request message before forwarding it. A Redirect Server may accept a SIP request, map the address into zero or more new addresses, and return these addresses to the client. In some cases, the Redirect Server may be designed such that it does not accept calls but does generate SIP responses that instruct a UAC to contact another SIP entity. As the name implies, a Registrar Server may accept REGISTER requests and may be co-located with a Proxy or Redirect server to offer these servers some level of location server-like assistance.

Referring back to system 10, a subscriber may have an SMS-enabled device. The user may also have an Enhanced Messaging Service (EMS) enabled device, a Multi-media Messaging Service (MMS) enabled device, and/or an Instant Messaging (IM) enabled device. These devices may be data only devices, cellular telephones, smartphones, PDA's, or some other wireless-enabled data communication device. An SMS or Short Message Service offering may involve the transmission of short text messages to and from a mobile phone, fax machine, and/or IP address. SMS Messages may be approximately 160 alphanumeric characters and may contain little or no images or graphics.

An MMS or Multi-media Messaging Service offering may involve a store-and-forward technique of transmitting graphics, video clips, sound files and short text messages over wireless networks using a protocol like Wireless Access Protocol (WAP). With SMS, EMS, MMS and other services, a carrier may deploy messaging servers 30 and 32 to implement the offerings.

With an MMS offering, the presentation characteristics of a message may be coded into a presentation file so that the images, sounds, and/or text are displayed at the recipient device as intended by the sender. To a subscriber, SMS, EMS, and MMS may operate in a similar manner. To an operator, MMS may be slightly different and may use its own standardized presentation protocol, Synchronized Multimedia Integration Language (SMIL).

SMIL may operate as a descriptive or markup language that performs functions similar to those performed by HTML on the Web. SMIL may provide a set of rules for integrating multimedia elements of text, images, audio, and video sequences in a multimedia message so that they can be transported across a network. SMIL may also control the display and layout of an MMS presentation, helping to ensure that the presentation of the multimedia elements may be delivered and presented in accordance with the sender's intent.

The elements of a specific multimedia message may be combined in a so-called SMIL container before transmission. This container may be linked to or encapsulated in a WAP file, which may provide information like sender and recipient addresses. In operation, a WAP portal may “see” the MMS message as it routes to a messaging service center 34 of an operator offering or supporting the messaging service. Messaging service center (MSC) 34 may include servers 30 and 32 to carry out different tasks. MSC 34 may have engines 36, 38, 40, and 42 to help support SMS, EMS, MMS, IM, and/or other offerings.

In some implementations, a message may be buffered in storage 44 and an intended recipient notified via a SEP-enabled mode. The notification may be provided in a WAP format and may contain the “name” of the sender, information about the message content, and a Web address (URL) needed to call up and retrieve the message. The Web address may be associated with MSC 34, a unified mailbox 46 associated with an intranet, extranet or (as depicted) with public Internet 48, or some other network-connected resource. From the recipient perspective, a message may download in response to a retrieval command, which may be initiated in several ways. For example, a user may press a button on phone 12 or interact with a graphical user interface (GUI) presented on a display associated with computer 16 or television 18.

After delivery, the sender may receive a confirmation of delivery from MSC 34. In operation, MMS messages may be delivered using packet-oriented transmission media capable of providing sufficient transmission capacities. These transmission media may employ a 2.5 G mobile technology like GPRS or EDGE. They may also employ higher bandwidth offerings like 3 G/UMTS.

The messages sent with an SMS offering may use the transmission capacity of the signaling channel of the Global System for Mobile communications (GSM) mobile network like mobile network 50, which may include cellular tower 52. Similarly, EMS or Enhanced Message Service may use sequential transmission of multiple SMS messages to transmit simple images and melodies.

However a message is sent, it should eventually be received by an appropriate device. One technique for accomplishing this delivery goal involves MSC 34. MSC 34 may send a request to a SIP Location Server and/or the home location register (HLR) 54 of the intended recipient to determine the location of the customer. The originally intended recipient device may be a wireless-enabled data device associated with a subscriber or user. Once HLR 54 receives the request, it may respond to MSC 34 with subscriber-related information such as active/inactive state, roaming/non-roaming status, and/or a forward to or copy new address condition.

If, for example, the response is “inactive,” MSC 34 may hold onto the message in storage 44 for a period of time or route it to mailbox 46. When the subscriber accesses the intended device, HLR 54 may send a notification to MSC 34, and MSC 34 may again attempt delivery of the message or a message waiting notice. When delivering a message, MSC 34 may transfer the message in a Point-to-Point format to the serving system. The serving system may page or notify the device, and if it responds, the message may be delivered. Once delivered, MSC 34 may receive verification that the message was received.

As mentioned above, MSC 34 may be informed that the subscriber has elected to have messages forwarded or copied to a new address location. The subscriber may be interacting, for example, with an active IM client on computer 16 connected to Internet 48 via a wired network. Computer 16 may be connected to Internet 48 via WLAN hub 22, xDSL modem 26, cable modem 28, a dial-up modem, some other network connection, and/or a combination thereof.

As shown in FIG. 1, xDSL modem 26 may connect a user to Internet 48 via telephone network 56, and cable modem 28 may connect a user to Internet 48 via cable network 58. Though not explicitly shown in FIG. 1, telephone network 56, cable network 58, mobile network 50, and Internet 48 may be interconnected in several topologies across various links.

As mentioned above, a subscriber may elect to have SMS messages, EMS messages, MMS messages, IM session messages, mobile alerts, data calls, or other messages originally received at the subscriber's wireless telephone 12 to be re-formatted and re-routed to the subscriber via an active IM client. As such, MSC 34 may effectively allow integration of wireless messaging with a wired messaging service or tool. In practice, interface 60 of MSC 34 may allow MSC 34 to interact and communicate with various networks and network nodes—facilitating messaging integration.

In some embodiments, a subscriber's wireless-enabled data device, like telephone 12, may include a wide area wireless transceiver and a local area wireless transceiver. The wide area wireless transceiver may be able to receive messages sent or addressed to the device via tower 52. The local area wireless transceiver may be able to transmit the messages received by the wide area wireless transceiver to network nodes of a local area wireless network. As such, a subscriber's wireless-enabled data device may effectively receive messages and “pass” the messages along to a different device like computer 16 or television 18, which may be interconnected with the subscriber's wireless-enabled data device across a WLAN established by WLAN hub 22.

The WLAN may include a wireless Ethernet link, which may comply with 802.11 (x). The WLAN may include a 2.4 GHz wireless link that complies with the Bluetooth standard. The WLAN may include a 900 MHz wireless link similar to those employed by a cordless telephone or even IR technologies. Whatever the link type or combination of link types, the WLAN may allow a subscriber to use different devices, which may be part of a home network, to interact with messages originally sent to the subscriber's wireless-enabled data device. In effect, the subscriber's wireless-enabled data device may allow the subscriber to link to a broader network through the device's wide area wireless transceiver.

In some embodiments, presence awareness and location based routing of data calls may be provided automatically by placing, for example, a mobile telephone handset or other electronic device capable of communicating data wirelessly in proximity to a detector located near an alternate destination. In some implementations, service-rich features such as distinctive ring, caller identification/privacy management and a common voicemail service for a user's wireless and wireline telephones may be possible when utilizing the system and methods disclosed herein.

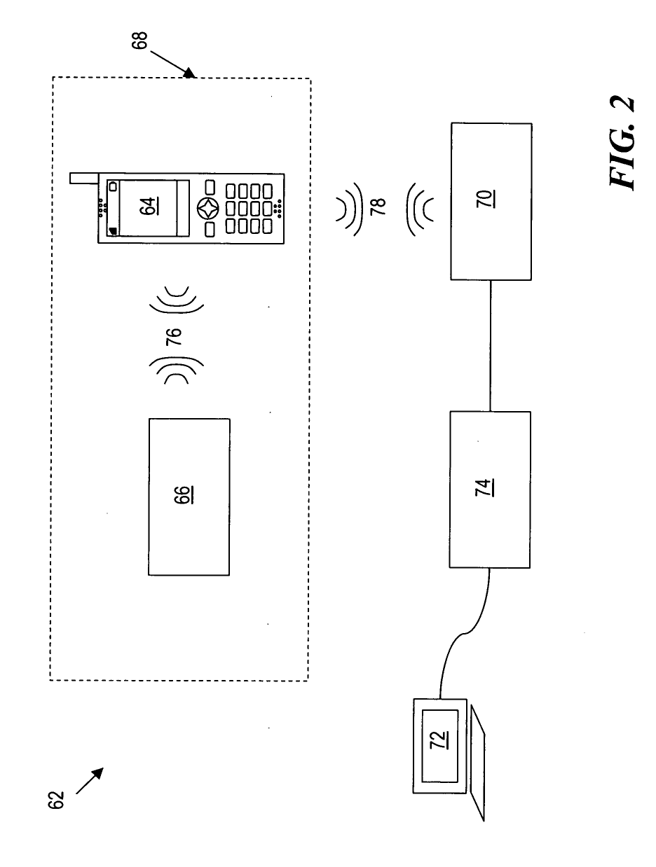

As mentioned above, FIG. 2 illustrates a communication system 62 that may be used to implement teachings of the present disclosure. Communications system 62 may include a mobile telephone 64 and an identifier transmitter 66 within a wireless detection area 68. Wireless detection area 68 may be provided by a wireless beacon that includes identifier transmitter 66. A communication interface may be located inside mobile telephone 64.

System 62 may also include a wireless switch 70 such as a cellular wide area switch, which may communicate with another electronic device 72 via network nodes associated with a communication service provider like node 74. Identifier transmitter 66 may communicate with the mobile telephone 64 via transmission signal 76. The wireless switch 70 may communicate with the mobile telephone 64 via a signal 78. In one embodiment, device 72 may have an address correlated with a landline telephone service. A wireless beacon device or identifier transmitter 66 may indicate proximity of telephone 64 to a wired network element such as a POTS telephone, a computer, or a WLAN hub communicatively coupled to a wired network.

In one embodiment, transmission signal 76 from the identifier transmitter 66 may utilize a wireless data protocol. The wireless data protocol may be the IEEE 802.11 standard wireless protocol, the Bluetooth standard protocol, or other wireless data protocols employed in the telecommunications industry. Generally, the signal 78 between the mobile telephone 64 and the wireless switch 70 could include a wireless data message protocol such as the Short Message Service (SMS) protocol. The wireless data message may be carried over various packet channels using protocols such as a Global System for Mobile communication (GSM) control channel, General Packet Radio Service (GPRS), universal Mobile Telecommunications Systems (UMTS) data, and/or CDMA2000/CDMAOne.

In one exemplary embodiment, a wireless telephone 66 may have Bluetooth functionality such as a class 3 type communication circuitry. A wireless beacon or identifier transmitter 66 may transmit a unique code using wireless data techniques, such as Bluetooth class 1 type communication. When in proximity to the wireless beacon 66, the wireless telephone 64 may receive the unique code from the wireless beacon 66. A module within the wireless telephone 64 may determine which network address is associated with the wireless beacon 66. The network address may, for example, be a landline telephone number, a Media Access Control (MAC) address, and/or an Internet Protocol (IP) address. In some embodiments, the network address may be transmitted as part of a unique code associated with the wireless beacon 66. The wireless telephone 64 may then send an SMS message via a wireless channel to facilitate call forwarding. Once the wireless telephone 64 leaves the coverage area 68, the wireless telephone 64 may send a cancel call-forwarding signal.

Utilizing multiple beacons, data and/or voice calls to a wireless telephone 64 may be forwarded to a different electronic devices when in various locations. For example, a user may have one wireless beacon located at home and another at work. Each wireless beacon may have a different unique identifier or may transmit a different forwarding address. The wireless phone may selectively activate and deactivate call forwarding by sending messages that include a network address associated the identified beacon.

The wireless beacon may also be used in conjunction with multiple wireless phones. Each phone may activate and deactivate call forwarding as it enters and leaves the wireless beacon coverage area. In some embodiments, each phone may activate a distinctive ring or notification technique utilized when a voice or data call is forwarded from such phone to the alternate electronic device. In other embodiments, each of the multiple wireless beacons may communicate additional coding to identify the network address. In further embodiments, wireless phones may selectively activate call forwarding when in proximity to a wireless beacon. If the wireless phone recognizes the identity of the wireless beacon, the wireless phone may activate and deactivate call forwarding when entering and leaving the wireless beacon coverage area. However, if the identity of the wireless beacon is not recognized or if coding does not match the value expected by the wireless phone, the wireless phone may ignore the wireless beacon. In such an example, a wireless telephone may enter an area covered by multiple wireless beacons and only respond to a single designated beacon.

To ensure that only authorized mobile devices may initiate call forwarding into the alternate network designated by the beacon, the beacon signal may be encrypted so that mobile devices with the correct public key can decrypt the signal and read the beacon identifier. Various methods exist for provisioning the beacon identifier and public key within the mobile device. One approach would be to run a short activation procedure between the beacon and the mobile phone using the first communications protocol. Further protection can be added so that a user login password is required to begin the activation procedure so that only the authorized user of the beacon may activate new mobile devices.

The illustrated embodiment of FIG. 2 depicts the mobile communication device 64 and a computer 72 communicatively coupled to a telephone network element 74. However, the concept may be generalized to call forwarding from one network address to a different network address, which may be associated with a different network. In another alternate embodiment, a multi-modal device may communicate using different networks depending on location.

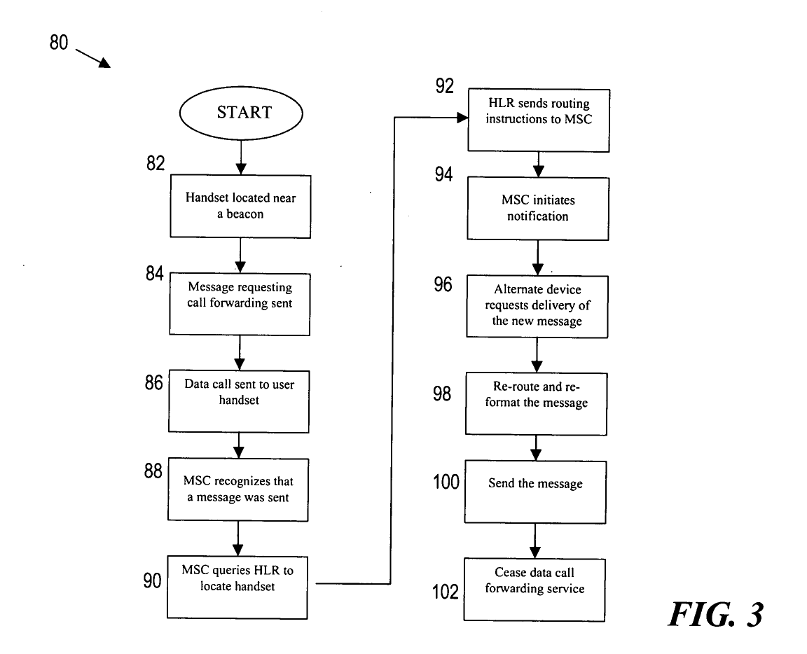

FIG. 3 presents a flow diagram illustrating one technique for feature activation when managing wireless data communication. The example provided in FIG. 3 illustrates technique 80, which may allow a cellular switching center (CSC), a messaging service center (MSC), an alternate address server, and a home location register (HLR) to interoperate. In step 82, a user places a handset near a wireless beacon, which causes at step 84 the handset to issue a short messaging service (SMS) message to a CSC asking in-bound calls to be ‘forwarded to’ a different address or telephone number. At step 86, a data call is sent to the user's handset. An MSC recognizes that the message was sent at step 88 and queries an HLR of the handset at step 90 to locate the handset. The HLR provides the MSC with routing instructions at step 92 that effectuate the user's desired call forwarding.

At step 94, the MSC sends a notification message, which may be sent via a Point-to-Point protocol to an alternate address indicating receipt of a new message. A device associated with the alternate address may, at step 96, request that the entire message be sent to the alternate address. At step 98, the message is forwarded to the new address and necessary reformatting may be performed. The reformatting may alter the message or messaging mechanism to facilitate communication via a different network and/or transport protocol. At step 100, the message is sent. At step 102, the user may take the cellular telephone away from the beacon and a cease forwarding command may be sent.

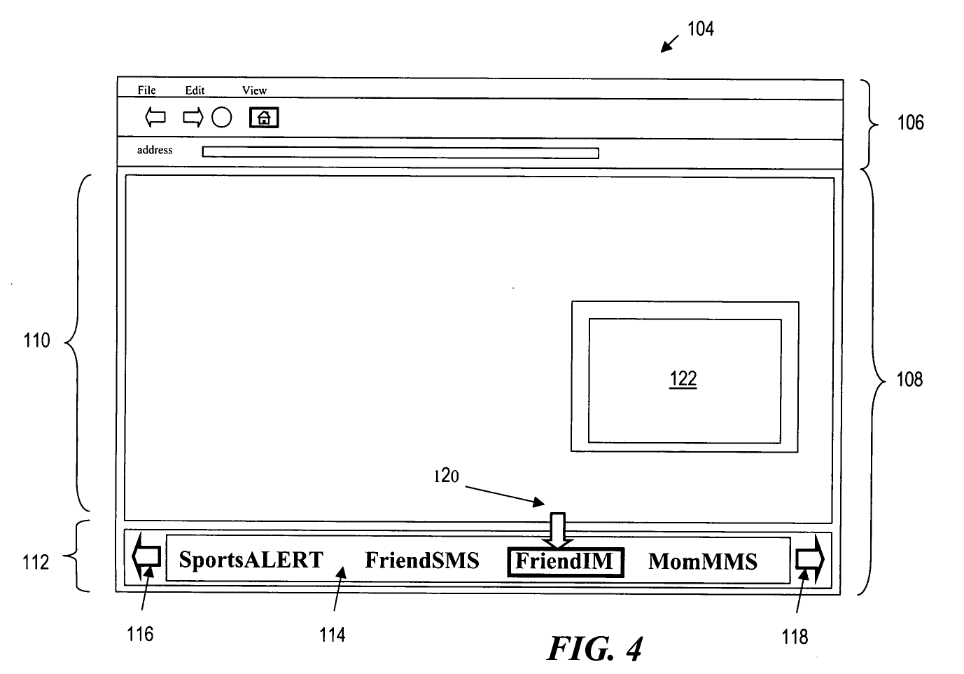

As mentioned above, FIG. 4 depicts a user interface 104 associated with a communication system that may be used to implement teachings of the present disclosure. Interface 104 may be a graphical user interface (GUI) presented on a computer screen in connection with a Web browser and a Web browsing session of a user. As shown, interface 104 includes a management pane 106 containing various soft buttons to initiate actions that may not be limited to the current page displayed in display pane 108. The page displayed in pane 108 may be a web page having a uniform resource locator (URL) address.

As depicted, display pane 108 may present a Web browsing window 110 and a messaging element 112. Messaging element 112 may be presented in several ways. Element 112 may be super imposed on pane 108 outside of a Web browsing environment, contained within a frame, presented within its own window and representing a separate browsing session, some other presentation technique, or combinations thereof. Element 112 may present a scrolling or ticker tape style display 114 of selectable items. As shown, the items may represent data messages of varying types that were sent to the user's wireless enabled data device. The device may be a PDA, a cellular telephone, a RIM device, or some other device capable of receiving wireless data.

As shown, the user may have recently received a sports related mobile alert, which may be an updated score or a reminder about an upcoming game. The user may have received an SMS and an IM message from another user named “Friend” and an MMS message from a user named “Mom.” The user names may correlate to an address book entry, which may be located on the user's wireless device, the user's computer, at a network location, and/or some other location.

Element 112 may also have GUI features. A user may be able to interact with the different images or icons presented in connection with element 112. The user may be able to scroll backwards through the list using icon 116 or forwards through the list using icon 118. As depicted, the user has selected “FriendIM” by pointing cursor 120 at the “FriendIM” item and left clicking on a mouse or selecting the enter key on a keyboard. In response to the selection, an IM session element 122 has been launched. In operation, the user may now engage in an IM session initiated by “Friend”. Interestingly, “Friend” may have initiated the session by sending a request to the user's wireless enabled device, but the user has accepted the IM invitation and launched the IM session from a different device.

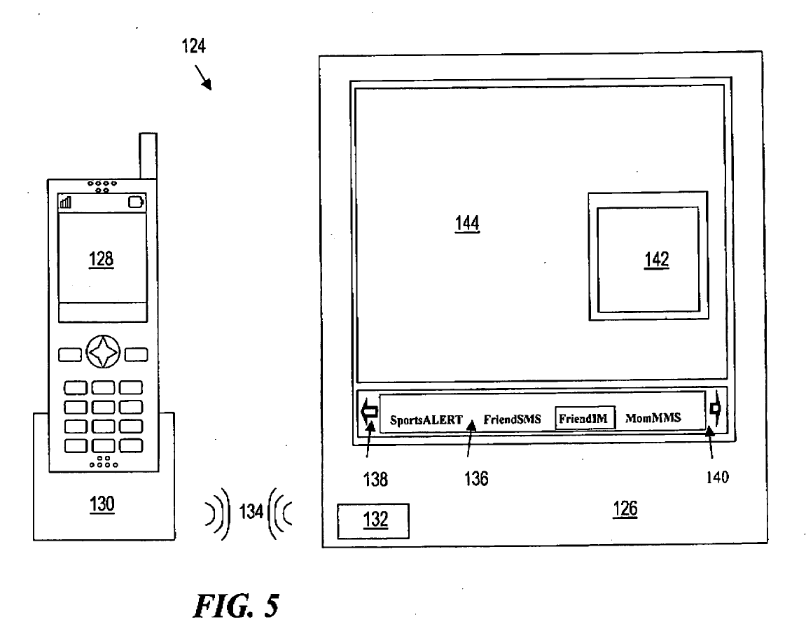

As mentioned above in the brief description of the drawings, FIG. 5 depicts a communication system 124 that may be used to implement teachings of the present disclosure to present messages on an alternate device. As depicted, system 124 includes a television 126 and a cellular telephone 128. Cellular telephone 128 may have been docked in device 130. Device 130 may include a wireless beacon and may, in some embodiments, be operable as a wireless local area network hub. As such, device 130 may be in communication with a wired network element such as a cable modem or xDSL modem.

Associated with television 126 is wireless receiver 132. Receiver 132 may be operable to communicate with device 130 using a Radio Frequency (RF) technology. Receiver 132 may couple to television 126 by plugging into a video input jack, a Universal Serial Bus (USB) port, and/or some other interconnection technique. In operation, device 130 may communicate with receiver 132 via a wireless signal 134. As depicted, wireless data messages and message notifications received by telephone 128 have been communicated across wireless link 134 and are being presented as selectable icons in scrolling display 136.

A user of system 124 may interact with television 126 and scroll forward using icon 138 or backward using icon 140 through the received messages and/or notifications. As depicted, the user has selected “FriendIM” and an IM session element 142 has popped-up on display 144. As such, a user may be able to watch a television show on display 144 of television 126 while also keeping track of wireless data being sent to telephone 128. Moreover, a user may make use of existing electronic devices to interact with a wireless messaging service. As such, the user may be able to conserve telephone 128's battery life and view messages on a display having a picture quality and screen size much better than that of telephone 128.

The various embodiments of the present invention involve the placing of telephone calls. These calls may comprise voice communications transmitted, either alone or in combination with data, video, or other messaging via either a public switched telephone network, a public or private wireless communication network, a private telephone network, via digital subscriber line access to a computer or telephony network, cable-television-based access to a computer or telephony network, satellite-based access to a computer or telephony network, or any combination thereof.

Based upon the herein-disclosed high-level description, one or more computer programs to direct one or more computers to perform the method is within the skill of a routineer in the art of telecommunications.

Embodiments of the herein-disclosed method may be directed by computer-readable instructions encoded on a computer-readable medium. The contents of the computer-readable medium cause at least one computer to perform the herein-disclosed acts. For this purpose, at least one computer processor is responsive to the contents of the computer-readable medium. Examples of the computer-readable medium include, but are not limited to, a computer-readable storage medium and a computer-readable communication medium. Examples of a computer-readable storage medium include, but are not limited to, an optical storage medium, an electronic storage medium, and a magnetic storage medium. The computer-readable storage medium may include stored data which encode computer program code and/or other computer-readable instructions.

Examples of a computer-readable communication medium include, but are not limited to, an optical communication medium, an electronic communication medium, and an electromagnetic communication medium. The contents of the computer-readable communication medium may include one or more waveforms which encode computer data such as computer program code and/or other computer-readable instructions.

In various embodiments, the wireless phone or wireless communication device may take various forms including personal digital assistants with built in communications circuitries, wireless telephones, cellular telephones, mobile telephones, and other wireless devices. Moreover, many of the devices, software, and/or pieces of equipment, referenced herein, may be SIP-enabled and may act, for example as a SIP UA.

The methods and systems described herein provide for an adaptable implementation. Although certain embodiments have been described using specific examples, it will be apparent to those skilled in the art that the invention is not limited to these few examples. Additionally, various types of wireless transceivers, transmitters, receivers, and protocols are currently available which could be suitable for use in employing the methods as taught herein. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

1. A system comprising:
a home location register for a wireless-enabled device having an address;
a messaging server operable to facilitate communication of wireless data to the wireless-enabled device, the messaging server further operable to send a request to the home location register;
a status identifier indicating that a different device having a different address should receive the wireless data; and
a response to the request, the response comprising the different address.

2. The system of claim 1, wherein the wireless-enabled device comprises a wireless telephone operable to receive voice calls and the wireless data and the address comprises a telephone number.

3. The system of claim 1, wherein the response to the request further comprises an indicator identifying a wireless network cell containing the wireless-enabled device.

4. The system of claim 1, wherein the different address comprises an internet protocol address.

5. The system of claim 1, further comprising an interface engine communicatively coupled to the messaging server, the interface engine operable to facilitate transmission of the wireless data call to the different address.

6. The system of claim 1, wherein the wireless-enabled device comprises a wireless telephone operable to receive voice calls and the wireless data and the address comprises a telephone number, further wherein the different address comprises an internet protocol address.

7. The system of claim 6, further comprising:
an interface engine communicatively coupled to the messaging server, the interface engine operable to facilitate transmission of the wireless data call to the different address; and
a formatting engine communicatively coupled to the interface engine, the formatting engine operable to prepare the wireless data for transmission to the different address.

8. The system of claim 1, wherein the wireless data is selected from a group consisting of an SMS message, an EMS message, a MMS message, a mobile alert, and an IM session message.

9. A system comprising:
a wireless communication device operable to receive a wireless voice call and a wireless data call, the wireless communication device comprising a display; and
a display engine operable to initiate presentation of an image on a television display, the image representing information sent to the wireless communication device.

10. The system of claim 9, wherein the information comprises a message sent using a service selected from the group consisting of electronic mail, mobile alerts, IM, SMS, EMS, and MMS.

11. The system of claim 9, wherein the display engine executes at a communication network node.

12. The system of claim 9, further comprising a communication module providing at least a portion of a communication path interconnecting the display engine and the television display.

13. The system of claim 9, further comprising a communication module having a local area wireless transceiver and operable to provide at least a portion of a communication path interconnecting the display engine and the television display.

14. The system of claim 9, further comprising a graphical user interface (GUI) element presented on the television display, wherein the image representing information sent to the wireless communication device presents in association with the GUI element.

15. The system of claim 14, wherein the image presents in a scrolling fashion.

16. The system of claim 14, wherein the information comprises a message sent using a service selected from the group consisting of electronic mail, mobile alerts, IM, SMS, EMS, and MMS, further wherein the image presents selectable images representing the information.

17. The system of claim 14, further comprising a communication module providing at least a portion of a communication path interconnecting the display engine and the television display.

18. The method of claim 17, wherein the wireless mobile communication device comprises a cellular telephone operable to utilize General Packet Radio Service.

19. A system comprising:
a wireless telephone configured to communicate using a wide area wireless protocol and configured to communicate using a proximal wireless protocol;
a call forward engine configured to send a call forward message when the wireless telephone is within a wireless beacon coverage area, the call forward message directing data messages that address the wireless telephone to be redirected to an address associated with a wired communication network; and
a wireless beacon device associated with the wired communication network and configured to communicate with the wireless telephone using the proximal wireless protocol when the wireless telephone is within the wireless beacon coverage area.

20. The system of claim 19, further comprising a cancel call forward engine configured to send a cancel call forward message in response to a determination that the wireless telephone has moved outside the wireless beacon coverage area.

21. The system of claim method of claim 20, wherein the call forward message and the cancel call forward message are sent using the wide area wireless protocol.

22. The method of claim 19, wherein the data messages comprise a message sent using a service selected from the group consisting of electronic mail, mobile alerts, IM, SMS, EMS, and MMS.

23. The system of claim 22, further comprising a display engine communicatively coupled to the beacon and operable to initiate presentation of an image on a television display, the image representing the message.

24. A method of managing communications, comprising:
communicatively coupling a wireless enabled device to a local area network (LAN) comprising a different electronic device;
receiving a data call at the wireless enabled device;
communicating via the LAN information comprised in the data call from the wireless enabled device to the different electronic device; and
presenting an image representing the information on a display associated with the different electronic device.

25. The method of claim 24, wherein the information comprises a notification of a waiting message.

26. The method of claim 25, further comprising:
selecting the image to initiate retrieval of the waiting message; and
launching a graphical user interface element to present the waiting message.

27. The method of claim 24, wherein the data call comprises a message sent using a service selected from the group consisting of electronic mail, mobile alerts, IM, SMS, EMS, and MMS.

28. The method of claim 24, further comprising altering a position of the image on the display.

29. The method of claim 24, further comprising presenting a graphical user interface element on the display to frame the image.

30. The method of claim 24, wherein the LAN comprises a wireless networking hub.

31. The method of claim 24, wherein the LAN comprises a home network, the wireless enabled device comprises a cellular telephone, and the different electronic device comprises a television.

32. the method of claim 24, further comprising:
recognizing that the wireless enabled device resides within a detection area of a wireless beacon associated with the LAN; and
communicating the information from the wireless enabled device to the wireless beacon utilizing a wireless local area networking protocol.

33. A method for managing wireless data communications, comprising:
recognizing that an incoming data message has an intended recipient address comprising an address associated with a wireless handset;
querying an element of a wireless service provider network to determine how to deliver the data message;
receiving a response to the query that comprises an alternate address associated with a different electronic device; and
sending the data message to the alternate address.

34. The method of claim 33, further comprising:
determining that the wireless handset resides within a coverage area of a wireless local area network (WLAN); and
sending a message to the element of the wireless service provider network requesting that messages addressed to the wireless handset be sent to the alternate address.

35. The method of claim 33, further comprising:
sending a message waiting notification to the alternate address;
receiving a request for delivery to the alternate address; and
reformatting the data message for delivery to the alternate address.
